(19) United States
(12) Patent Application Publication
(10) Pub. No.: US 2002/0154874 A1
(43) Pub. Date: Oct. 24, 2002

(54) Radiation shielded optical waveguide and method of making the same

(76) Inventors: Robert G. Ahrens, Chatham, NJ (US); David John DiGiovanni, Montclair, NJ (US); Robert Scott Windeler, Annandale, NJ (US)

Correspondence Address: Docket Administrator (Room 3C-512), Lucent Technologies Inc., 600 Mountain Avenue, P.O. Box 636, Murray Hill, NJ, 07974-0636, US

(21) Appl. No.: 09/839,750

(22) Filed: Apr. 20, 2001

(51) Int. Cl. G02B 6/16

(52) U.S. Cl. 385/123; 385/142

(57) ABSTRACT

An optical waveguide comprising a silica structure and a number of radiation shielding dopant atoms. At least some of the radiation shielding dopant atoms are chemically bonded with at least some of the constituents of silica structure. As such, the radiation shielding dopants are fixed within the silica structure to shield the optical waveguide from at least one of alpha-, beta-, gamma-, x-, and neutron-radiation.

### FIELD OF THE INVENTION

The present invention relates to optical waveguides.

### BACKGROUND OF THE INVENTION

Optical waveguides, such as optical fibers, are employed in the transport of optical signals. Optical waveguides typically comprise a core surrounded by a cladding. If the refractive index of the core exceeds the refractive index of the cladding, an optical signal launched into the core may propagate therethrough, remaining contained within the length of the core.

The core and cladding of an optical waveguide typically comprise silica having a matrix structure. Such silica-based optical waveguides are susceptible to damage from ionizing radiation. More specifically, exposure to alpha-, beta-, gamma-, x-, or neutron-radiation may cause some of the chemical bonds within the structure of the silica to break, thereby displacing the atoms within the structure. As a result, the silica core and cladding densifies, creating defects or “color centers.” Consequently, the propagation and attenuation characteristics of an optical waveguide exposed to ionizing radiation are undesirably changed. Unfortunately, such exposure may be unavoidable as, for example, when the optical waveguide is used in nuclear or space applications.

Various solutions have been proposed to reduce the susceptibility of optical waveguides to changed characteristics upon exposure to ionizing radiation. For example, implantation of certain dopants, including hydrogen and its isotopes, such as deuterium, into the structure of silica may protect the waveguide from damage induced by ionizing radiation. However, implanted hydrogen and its isotopes easily diffuse out of the structure of silica. To counter this out-diffusion, known solutions to date have focused on providing housing and packaging structures that maintain an optical waveguide in a hydrogen or deuterium rich environment. Disadvantageously, such housing and packaging structures add cost and complexity to the overall optical waveguide structure.

### SUMMARY OF THE INVENTION

We have invented a method for passivating radiation shielding dopants, such as hydrogen or deuterium, within a glass or silica structure. For the purposes of the present invention, passivating means suppressing the out-diffusion of the radiation shielding dopants from the silica structure. In accordance with the present invention, we have discovered that the radiation shielding dopants passivate the silica structure upon exposure to electromagnetic radiation or a thermal field. Thus, by exposing an optical waveguide implanted with radiation shielding dopants to electromagnetic radiation or a thermal field, the radiation damage may be substantially eliminated, thereby eliminating the need for the housing and packaging structures of the known art. We have found gamma and ultra-violet radiation may be particularly effective to this end.

One explanation for the passivation of the radiation shielding dopants may be that the radiation shielding dopants become fixed within the silica structure. We believe that this fixing may be caused by at least some of the implanted radiation shielding dopants chemically bonding with at least some of the constituents of the silica structure upon exposure to electromagnetic radiation. Depending on the optical waveguide, these constituents may include oxygen, silicon, germanium, phosphorus, aluminum, fluorine, chlorine, ytterbium or erbium.

### BRIEF DESCRIPTION OF THE DRAWINGS

The present invention will be better understood from reading the following description of non-limiting embodiments, with reference to the attached drawings, wherein below:

FIGS. 1(a) through 1(d) are cross-sectional views of an embodiment of the present invention;

FIG. 2 is a flow chart according to the present invention;

FIG. 3 is an illustration comparing a first aspect of the present invention;

FIG. 4 is an illustration comparing a second aspect of the present invention; and

FIG. 5 is a graphical illustration of our experiment data.

It should be emphasized that the drawings of the instant application are not to scale but are merely schematic representations, and thus are not intended to portray the specific dimensions, as will be apparent to skilled artisans.

### DETAILED DESCRIPTION OF THE INVENTION

The damaging effects of ionizing radiation on glass or silica-based optical waveguides may be overcome by the use of hydrogen or one of its isotopes, such as deuterium. Hydrogen and its isotopes are known to prevent damage to silica and its structure from ionizing radiation. Advantageously, hydrogen and its isotopes are known to easily diffuse in the silica or glass. However, hydrogen and its isotopes are known also to easily diffuse out from silica. Consequently, the solutions to date focused on specially designed housing and packaging structures for maintaining the optical waveguide in a hydrogen- or hydrogen-isotope-rich environment.

In accordance with an embodiment of the present invention, a method is disclosed for affixing radiation shielding dopants, such as hydrogen or one of its isotopes, within a silica-based optical waveguide. More particularly, a method is disclosed for affixing radiation shielding dopants within a silica structure to prevent the out-diffusion of at least some of the dopants. By exposing the silica structure to electromagnetic radiation or a thermal field, the radiation shielding dopants become fixed with the silica structure. Consequently, a silica structure, such as an optical waveguide, having radiation shielding dopants fixed therein may be shielded from ionizing radiation, including alpha-, beta-, gamma-, x-, and neutron-radiation.

Our method promotes the passivation of the radiation shielding dopants, for example, within a propagation core and cladding of the optical waveguide. In one example, the radiation shielding dopants are fixed within a propagation core and cladding of the optical waveguide by promoting the formation of bonds between the radiation shielding dopants and constituents of the silica structure. It is believed that upon executing the steps, as detailed hereinbelow, some of the implanted radiation shielding dopants chemically bond with a number of constituent atoms within the structure of the silica. The constituent atoms may include oxygen, silicon, germanium, phosphorus, aluminum, fluorine, chlorine, ytterbium and/or erbium, depending on the application of the silica and the functional purpose of any other dopants, such as erbium and ytterbium, for example, employed in addition to the radiation shielding dopants.

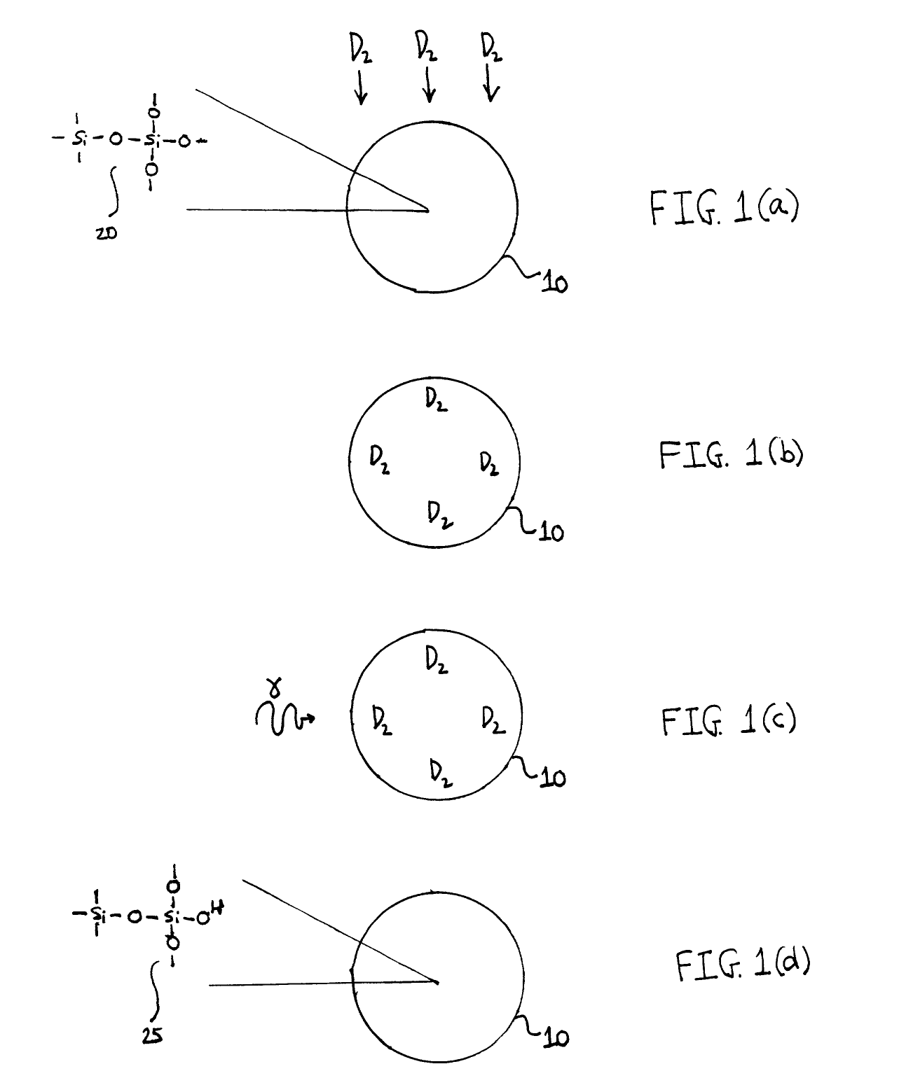

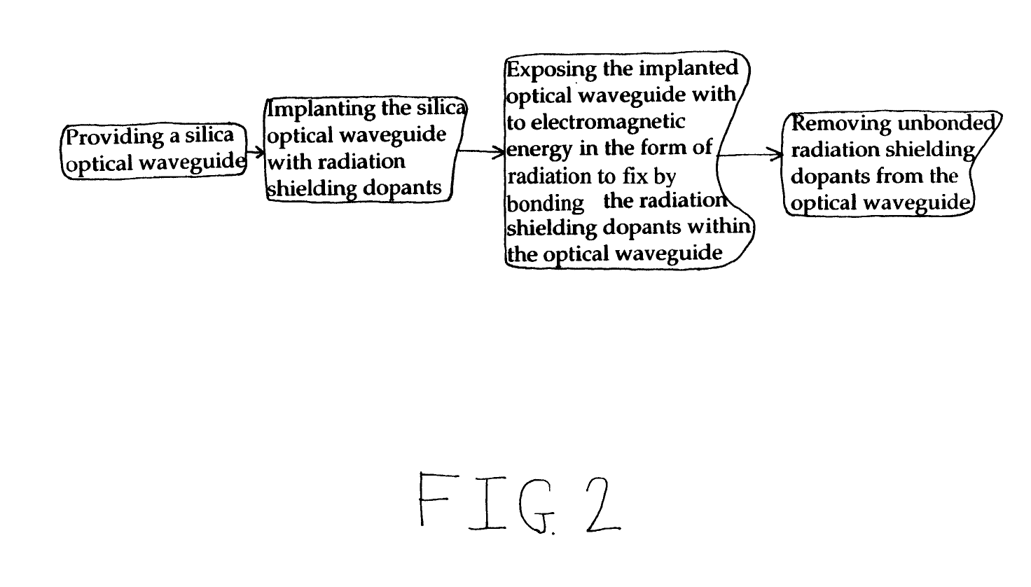

Referring to FIGS. 1(a) through 1(d) and FIG. 2, an embodiment of the present invention is illustrated. More particularly, an optical waveguide 10 is shown undergoing a series of processing steps according to the present invention. Optical waveguide 10 is representative of various optical devices, including an optical fiber having a propagation core and a cladding, an optical fiber laser, an erbium or ytterbium doped fiber amplifier, a planar waveguide, as well as a Bragg grating, for example. Other applications of the present invention, however, will be apparent to skilled artisans upon reviewing the instant disclosure.

Optical waveguide 10 comprises a silica structure 20. Silica structure 20 comprises a number of silicon (Si) atoms, each of which is chemically bonded with four oxygen atoms (O). Depending on the application intended for optical waveguide 10, silica structure 20 may also incorporate additional constituents therein, including a lanthanide dopant, such as erbium or ytterbium, as well as other functional dopants, such as germanium or phosphorus.

Referring to FIG. 1(a), a first process step is performed on optical waveguide 10. Here, a dose of radiation shielding dopants is implanted into optical waveguide 10 to achieve a desirable radiation shielding dopant concentration within waveguide 10. As illustrated, deuterium is employed radiation shielding dopants. The radiation shielding dopants may be selected from a group including hydrogen and its isotopes, such as deuterium.

Various radiation shielding dopant concentrations may be employed to achieve the purpose of the present invention. In one example, a dopant concentration of 23,000 parts per million of silicon (Si) atoms may be realized at the propagation core of an optical fiber having a diameter of 125 μm. In another example, a dopant concentration of at least 10 parts per million of deuterium atoms may be realized at the propagation core of an optical fiber having a diameter of 125 μm. It will be apparent to skilled artisans that the range of operable concentrations may also depend on the application intended for optical waveguide 10.

The implantation step may be realized by various techniques known to skilled artisans. One exemplary process technique is diffusion. To load optical waveguide 10 with radiation shielding dopants by a diffusion step, the temperature and pressure of the environment (e.g., chamber) where the implantation step is performed should be controlled. Exemplary operable ranges include a temperature between 20° C. to 80° C., and a pressure between one (1) atmosphere and 500 atmospheres. It will be apparent to skilled artisans that other operable pressure and temperature ranges may be employed to realize the desired radiation shielding dopant concentration. In selecting these operable parameter values, consideration should be given to temperatures which may damage the optical waveguide 10. It will also be apparent to skilled artisans that the length of time required to load waveguide 10 to the desired concentration by diffusion corresponds with the temperature and pressure values employed—lower temperature and pressure values will require a greater time period than higher temperature and pressure values.

Referring to FIG. 1(b), the result of the first process step is illustrated. Optical waveguide 10 is shown loaded with a concentration of radiation shielding dopants. While the radiation shielding dopants are implanted into optical waveguide 10, it should be noted that these dopants may likely diffuse from waveguide 10 after the passage of a relatively short period of time (e.g., 24 hours).

Referring to FIG. 1(c), a second process step is performed on optical waveguide 10. Optical waveguide 10 is exposed to electromagnetic radiation to passivate, such as affix, for example, the radiation shielding dopants within optical waveguide 10. Various forms of electromagnetic radiation may be utilized, including gamma and ultra-violet, for example. In the alternative, optical waveguide 10 may be exposed to a thermal field in a temperature range of 50° C. and 600° C., as a substitute to the use of electromagnetic radiation.

As a result of the step of exposing optical waveguide 10 to electromagnetic radiation or a thermal field, some of the radiation shielding dopants implanted within optical waveguide 10 may bond with at least some of the constituents of silica structure 20. It is believed that each radiation shielding dopant atom fixed within optical waveguide 10 forms a chemical bond with, for example, at least one oxygen atom. Chemical bonds with other constituents may be also formed.

It should be noted that some of the implanted radiation shielding dopants may not bond within silica structure 20. These remaining radiation shielding dopants may be removed by various known process steps. In one example, these remaining radiation shielding dopants may be removed through a combination of heat and pressure to facilitate their out-diffusion from optical waveguide 10.

The remaining radiation shielding dopants, however, may be reduced by increasing the chemical bonding activity. We believe the amount of chemical bonding between the radiation shielding dopants and constituents of silica structure 20 corresponds with the rate of exposure to electromagnetic radiation. For example, optical waveguide 10 may be irradiated at a rate of about 100,000 rads per hour such that about 75 percent of the implanted radiation shielding dopants may be initially trapped within silica structure 20. In this example, we believe that perhaps some or all of the 75 percent of the implanted radiation shielding dopants, which are initially trapped within silica structure 20 may become fixed within structure 20. Consequently, we believe it may be advantageous if optical waveguide 10 is exposed to electromagnetic radiation at a rate of at least one (1) rads per hour to substantially reduce the remaining radiation shielding dopants unbonded within silica structure 20.

Referring to FIG. 1(d), the result of the previous process step is illustrated. Optical waveguide 10 is shown having a modified silica structure 25. Modified silica structure 25 comprises a number of radiation shielding dopants, such as deuterium atoms. These radiation shielding dopants are passivate silica structure 25. In one explanation of the present invention, the radiation shielding dopants may be viewed as chemically bonded within modified silica structure 25. Consequently, the radiation shielding dopants may be viewed as being affixed within optical waveguide 10, and more particularly within modified silica structure 25. By bonding within silica structure 25, the radiation shielding dopants shield resultant optical waveguide 10 from subsequent exposure to alpha-, beta-, gamma-, x-, or neutron-radiation.

Upon completion of the above process, optical waveguide 10 may be characterized as including means for affixing the radiation shielding dopants within silica structure 25. The means for affixing the radiation shielding dopants prevents the out-diffusion of the radiation shielding dopants from structure 25. The means for affixing the radiation shielding dopants comprises the bonds created between the radiation shielding dopants and silica structure 25. For example, the means for affixing the radiation shielding dopants may be realized by the chemical bonds between the radiation shielding dopants and the oxygen atoms of silica structure 25.

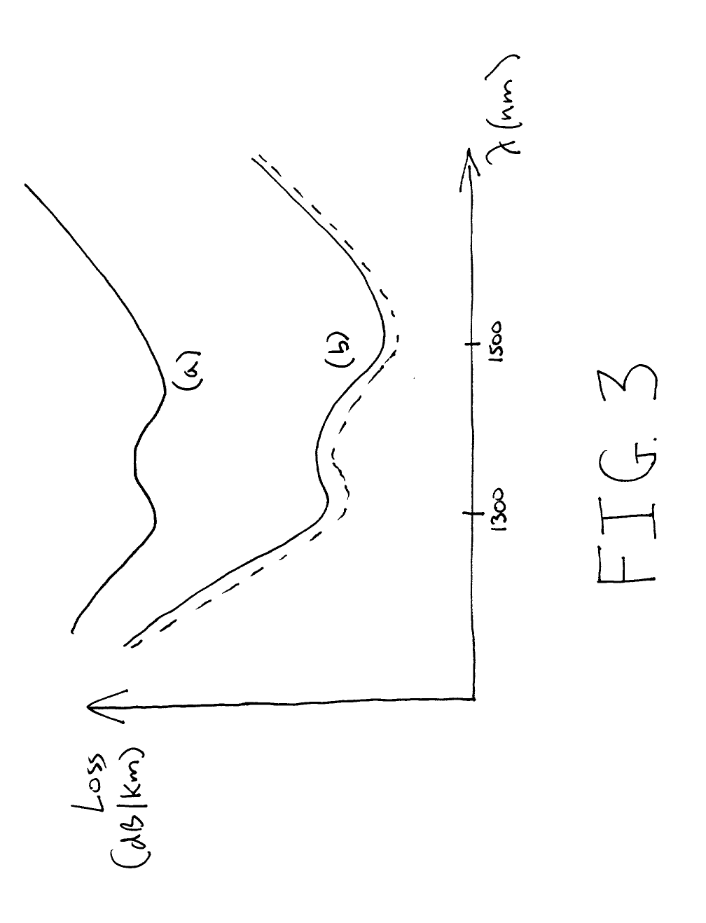

Referring to FIG. 3, the loss characteristics of an optical waveguide are illustrated, as a function of wavelength. More particularly, the loss characteristics of an optical waveguide formed from silica and damaged by ionizing radiation are shown curve (a). As illustrated, the damaged optical waveguide has substantially higher loss characteristics, particularly in the optical communication bands—namely, the 1300 nm and 1500 nm bands—in comparison with a typical undamaged optical fiber (shown as a dashed line).

In contrast, curve (b) illustrates the loss characteristics of an optical waveguide employing radiation shielding dopants. As shown, the loss characteristics in the communication bands in the optical waveguide of the present invention minimally increase over a typical undamaged optical fiber. Notably, these loss characteristics also closely track the loss characteristics of the undamaged optical fiber.

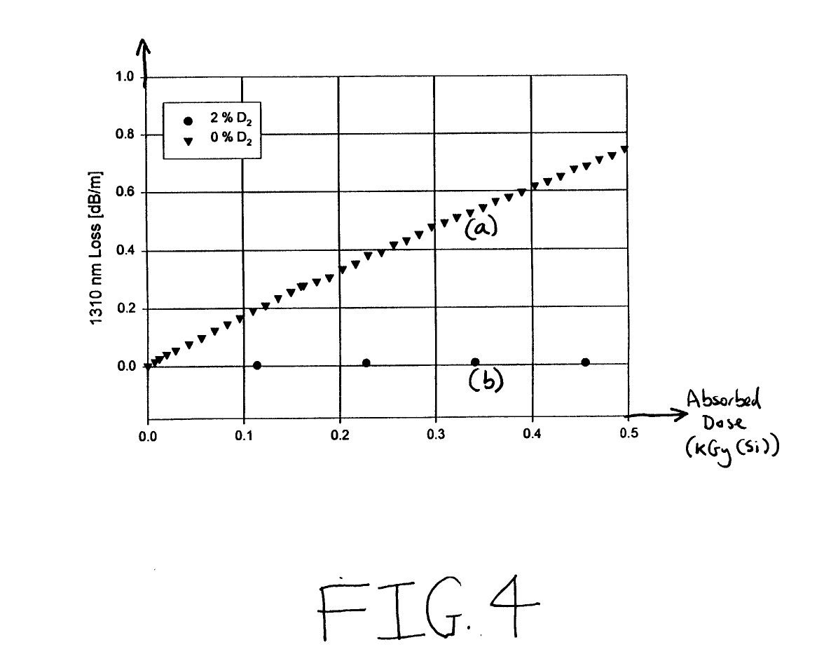

Referring to FIG. 4, the loss characteristics of an optical waveguide are illustrated, as a function of wavelength. More particularly, the loss characteristics of an optical waveguide formed from silica in the 1300 nm band damaged by ionizing radiation are shown in curve (a). As illustrated, the loss characteristics of a damaged optical waveguide increase proportionately with an increase in exposure (i.e., absorbed dose) to damaging ionizing radiation.

In contrast, curve (b) illustrates the loss characteristics of an optical waveguide formed from silica in the 1300 nm band employing radiation shielding dopants. As shown, the loss characteristics minimally increase with increasing exposure to damaging ionizing radiation. It is believed that these relatively minimal effects may be further reduced by increasing the irradiation rate of the optical waveguide to induce increased chemical bonding between radiation shielding dopants and the constituents of the silica structure.

### EXAMPLE

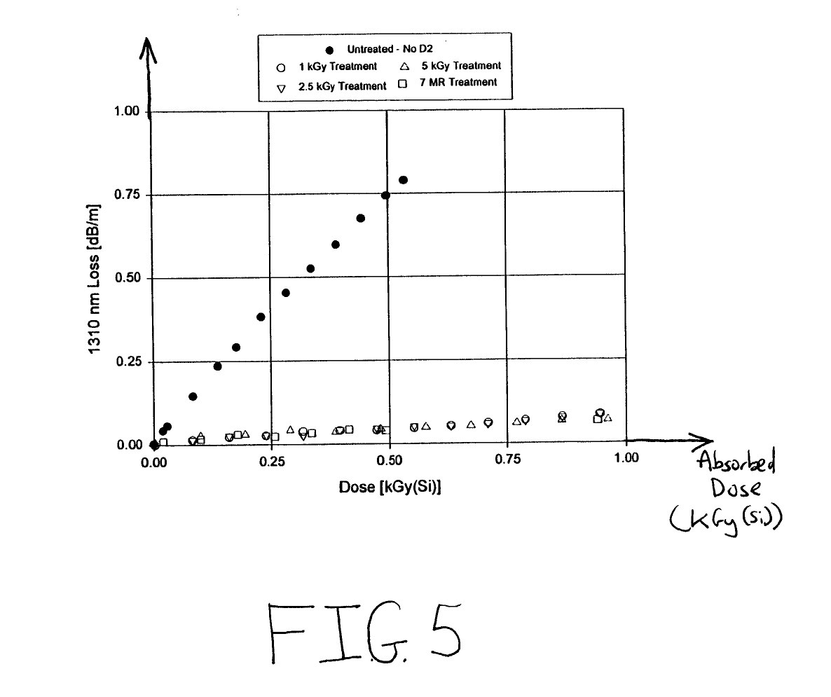

In an experiment, four erbium-ytterbium optical fiber samples were treated in accordance with the steps disclosed hereinabove. These samples were examined and compared with an untreated erbium-ytterbium optical fiber sample. Data from the treated and untreated fiber samples was collected. Each of the treated fiber samples was loaded with molecular deuterium to a propagation core concentration of 24,000 parts per million, and irradiated at a rate of 1.08 kGrays(Si) per hour. Each of the treated fiber samples received differing total absorbed doses—1, 2.5, 5 and 70 kGrays(Si). Following the irradiation cycle, each of the treated samples was heated in a furnace at a temperature of 60° C. for 120 hours to accelerate the out-diffusion of molecular deuterium from the treated optical fiber samples. The data results of our experiment are shown in FIG. 5. As a consequence of experiment and the data collected, we believe that each of the treated fiber samples exhibits an order of magnitude reduction in radiation sensitivity up 1.0 kGray(Si), in comparison with the untreated fiber sample.

While the invention has been described with reference to illustrative embodiments, this description is not meant to be construed in a limiting sense. It is understood by skilled artisans that although the present invention has been described, various modifications of the illustrative embodiments, as well as additional embodiments of the invention, will be apparent upon reference to this description without departing from the spirit of the invention, as recited in the claims. It is therefore contemplated that the claims will cover any such modifications or embodiments as fall within the true scope of the invention.

1. A method comprising:
exposing an optical waveguide implanted with radiation shielding dopant atoms to at least one of electromagnetic radiation and a thermal field, wherein at least some of the radiation shielding dopant atoms are passivated within the optical waveguide.

2. The method of claim 1, wherein the optical waveguide comprises silica having constituents, and the step of exposing fixes at least some of the radiation shielding dopant atoms with at least some of the constituents of the silica.

3. The method of claim 1, wherein the step of exposing creates bonds between at least some of the radiation shielding dopant atoms with at least some of the constituents of the silica.

4. The method of claim 3, wherein each bond comprises at least one chemical bond between at least one of the radiation shielding dopant atoms and at least one constituent of the silica.

5. The method of claim 4, wherein the at least one constituent of the silica comprises at least one of oxygen, silicon, germanium, phosphorus, aluminum, fluorine, chlorine, ytterbium and erbium.

6. The method of claim 3, further comprising the step of removing a remainder of radiation shielding dopants from the optical waveguide unbonded with the silica.

7. The method of claim 1, wherein the step of exposing comprises irradiating the optical waveguide with at least one of gamma and ultra-violet radiation.

8. The method of claim 1, wherein the thermal field heats the optical waveguide in the range of 50° C. and 600° C.

9. The method of claim 1, wherein the radiation shielding dopants comprise at least one of hydrogen and a hydrogen isotope.

10. The method of claim 9, wherein the implanted optical waveguide has a dose concentration of radiation shielding dopants of at least 10 parts per million of the at least one of hydrogen and a hydrogen isotope, and the optical waveguide is irradiated at a rate of at least approximately 1 rads per hour.

11. A method of fixing radiation shielding dopants in silica comprising:
exposing the silica implanted with the radiation shielding dopant atoms to at least one of electromagnetic radiation and a thermal field, wherein at least some of the radiation shielding dopant atoms are passivated within the silica.

12. The method of claim 11, wherein the silica comprises constituents, and the step of exposing fixes at least some of the radiation shielding dopant atoms with at least some of the constituents of the silica.

13. The method of claim 11, wherein the step of exposing creates bonds between at least some of the radiation shielding dopant atoms and at least some of constituents of the silica.

14. The method of claim 13, wherein each bond comprises at least one chemical bond between at least one of the radiation shielding dopant atoms and at least one constituent of the silica.

15. The method of claim 14, wherein the at least one constituent of the silica comprises at least one of oxygen, silicon, germanium, phosphorus, aluminum, fluorine, chlorine, ytterbium and erbium.

16. The method of claim 13, further comprising the step of removing a remainder of radiation shielding dopants unbonded with the silica.

17. The method of claim 11, wherein the step of exposing comprises irradiating the silica with at least one of gamma and ultra-violet radiation.

18. The method of claim 11, wherein the thermal field heats the silica in the range of 50° C. and 600° C.

19. The method of claim 11, wherein the radiation shielding dopants comprise at least one of hydrogen and a hydrogen isotope.

20. The method of claim 19, wherein the implanted silica has a dose concentration of radiation shielding dopants of at least 10 parts per million of the at least one of hydrogen and a hydrogen isotope, and the silica is irradiated at a rate of at least approximately 1 rads per hour.

21. An optical waveguide comprising:
radiation shielding dopant atoms; and
means for passivating the radiation shielding dopant atoms within a silica structure such that the optical waveguide is shielded from ionizing radiation.

22. The optical waveguide of claim 21, wherein the means for passivating minimizes the radiation shielding dopant atoms from diffusing out of the silica structure.

23. The optical waveguide of claim 22, wherein means for passivating comprises means for fixing the radiation shielding dopant atoms within the silica structure.

24. The optical waveguide of claim 23, wherein the means for fixing fixes the radiation shielding dopants within at least one of a propagation core and a cladding in the optical waveguide.

25. The optical waveguide of claim 23, wherein the silica structure has constituents, and the means for fixing comprises a number of bonds between at least some of the radiation shielding dopant atoms and at least some of the constituents of the silica structure.

26. The optical waveguide of claim 25, wherein each bond comprises at least one chemical bond between at least one of the radiation shielding dopant atoms and at least one constituent of the silica structure.

27. The optical waveguide of claim 26, wherein the at least one constituent of the silica structure comprises at least one of oxygen, silicon, germanium, phosphorus, aluminum, fluorine, chlorine, ytterbium and erbium.

28. The optical waveguide of claim 21, wherein the radiation shielding dopants comprise at least one of hydrogen and a hydrogen isotope.
